(19) United States
(12) Patent Application Publication
(10) Pub. No.: US 2025/0286896 A1
(43) Pub. Date: Sep. 11, 2025

(54) METHODS & SYSTEMS FOR SYNCHRONISING AND CONTROLLING STATE WITHIN COMPUTER-IMPLEMENTED ENVIRONMENTS

(71) Applicant: nChain Licensing AG, Zug (CH)

(72) Inventor: Craig Steven WRIGHT, London (GB)

(21) Appl. No.: 18/859,099

(22) PCT Filed: Apr. 17, 2023
(86) PCT No.: PCT/EP2023/059887

§ 371 Date: Oct. 22, 2024

(30) Foreign Application Priority Data
Apr. 25, 2022 (GB) 2205953.9

(51) Int. Cl. H04L 9/40

(52) U.S. Cl. CPC H04L 63/107

(57) ABSTRACT

A computer-implemented method of broadcasting a presence of first actor (O1) within or near said zone (Z), of a domain (D) comprising a plurality of zones (Z) that are at least one of: a physical entity represented by spatial or geospatial data; representable as a virtual zone in a virtual domain; and representable as an entry within a database or data table. A zone can comprise functionality and/or variables; and/or controlled by a program representing the zone. The domain (D) can be at least one of a distributed data structure and/or configured on a distributed ledger. The method broadcasts to at least another actor (O2) within the domain. At least one transmission contains data that enables the at least another actor (O2) to determine proximity of a first actor (O1) to the zone (Z). The domain can be a network, an environment or domain, such as a warehouse.

### CROSS REFERENCE TO RELATED APPLICATIONS

This application is the U.S. National Stage of International Application No. PCT/EP2023/059887 filed on Apr. 17, 2023, which claims the benefit of United Kingdom Patent Application No. 2205953.9, filed on Apr. 25, 2022, the contents of which are all incorporated herein by reference in their entireties.

### TECHNICAL FIELD

The present disclosure relates generally to methods and systems for enabling secure communications between a plurality of actors e.g. users operating within a domain that has zones. Such domains can comprise computer implemented environments, including but not limited to, virtual machines (VMs), execution threads and/or processes, or network enclaves etc. Advantageously, embodiments of the disclosure can be used to synchronise, monitor and control the operations of actors within zones, leading to numerous technical advantages such as ensuring state consistency and enhancing security.

In accordance with one or more embodiments, an actor can monitor the domain, or part thereof, and actors can determine the presence of another actor, and also engage and interact with the zone. The domain, and parts thereof, can represent real-world and/or digital assets. The assets can have functions and/or variables. Embodiments provide enhanced and cryptographically secure solutions for processing of sensitive or secret data within a domain, and provide a platform and/or underlying mechanism which a wide variety of technical implementations can utilise for advantage. The invention is particularly suited for, but not limited to, use with blockchain related technologies.

### BACKGROUND

It is necessary to control and/or monitor the existence, actions and relevant data of users (actors) within a computer system so as to maintain state consistency and the integrity of data within the system. State consistency is essential in order to ensure that there is one version of reality that can be trusted by all users of the system. For example, it is understood in respect of graph databases and distributed systems that the actions of multiple users at different times can result in overlapping/conflicting outcomes. Avoiding inconsistencies, and ensuring synchronisation of data and state, is particularly challenging over distributed networks and systems because users typically act independently of one another as they use and navigate around the system, and can dynamically come and go. In addition to mitigating overlap, implementing and controlling a record system and means for tracking changes to the actors within the system can require, or at least benefit from, permanent, immutable records of the functions performed at, or by, an entity and changes to any variables. The present disclosure seeks to provide techniques which alleviate or eliminate at least these technical challenges.

### SUMMARY

The methods and systems herein support, generally, communications from at least one actor to all other actors in a given domain, and between two or more actors occupying the same space/zone within said domain. The domain, and zones within the domain, are preferably provided with functionality and/or attributes. Methods disclosed herein can support monitoring and/or synchronisation of the functions performed by a plurality of actors in the same zone and/or the changes to the attributes.

Consider an illustrative but non-limiting scenario in which multiple actors e.g. users are active within a computer-based system comprising multiple environments. These environments could comprise one or more of, for example, a virtual machine (VM), code segment, thread, process or ‘box’. In other examples, an environment could comprise or have access to a segment of a database or data storage resource or other resources. In accordance with a preferred embodiment, such environments can be modelled as a room, table or other data structure. We may refer to a room as a ‘zone’ within a wider domain/system.

Preferably, one or more actors can be located in (i.e. active within or belonging/subscribing to) a given environment or portion thereof at a specific point in time, but a given actor can only be in one room at any point in time. In some cases, an actor may be deemed active or located within an environment when it wishes to perform an operation such as, for example, access data and/or write data to a resource associated with that environment. In other examples, an actor may be considered as being in the room when it signals its presence to other actors. Actors may enter and exit rooms.

The ‘room’ may comprise one or more computing resources. These resources can comprise hardware, software and/or firmware. Therefore, each room may be capable of, for example, receiving and sending communications, storing data (state), providing data etc. A room may comprise a controller that authorises and/or specifies the functionality that is associated with that room. A room and/or its controller may be subordinate to a domain/controller.

An actor may wish to perform certain functions and operations in respect of a room that it has entered, such as writing data to a storage resource associated with the room. As a result, other actors that are present in the same room need to be aware of the actor's presence. They may also need to know the data and/or actions that the actor wishes to make. Actors in a room may need to:
1. Interact and engage with one another;
2. Lock data that they wish to operate on, so as to prevent inconsistencies;
3. Interact with resources that are associated with the room.

In a preferred embodiment, n data rooms within a system can be described as {R₀, R₁, . . . . Rₙ₋₁}. Each room in the system may be described or defined through the use of a random function that generates seeds: {r₀, r₁, . . . . rₙ₋₁}. With knowledge of rᵢ, a user can unlock and obtain knowledge of the structure of Rᵢ.

Preferably, each data room is locked using a key {K₀, K₁, . . . . Kₙ₋₁}. They may be linked e.g. by using a hash chain or a key generation algorithm that allows sub keys to be derived from master keys. In a preferred embodiment, a user in a given room Rᵢ may encrypt and send transmit data using key kᵢ. Preferably, all users in the same room Rᵢ can use the key kᵢ. The key kᵢ. may enable the actor(s) in the room to see and/or access data and resources in the room. This enables the state of room Rᵢ to be read by actors within that room, but not others.

The key for a given room may be updated over time or when a triggering event occurs, e.g. when a user changes rooms.

Preferably, a bit commit can be set and used for each room, as described in more detail below.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client implementation,

FIG. 3B is a schematic mock-up of an example user interface that may be presented by the client implementation of FIG. 3A,

FIG. 4 is a schematic block diagram of some node software for processing transactions,

FIG. 5 is a schematic block diagram representing the domain, sub-domain, zones and sub-zones representing entities or locations in which operators communicate and function, and

FIG. 6 is a flow-chart representing communications between two operators.

### DETAILED DESCRIPTION OF EMBODIMENTS

According to one aspect disclosed herein, there is provided a method and corresponding system for secure communication or indication of the presence of a first actor of/within a computing environment that is implemented as a component of a computer-based system/environment. Additionally, or alternatively, the disclosure may be described as providing enhanced computer-implemented solutions for broadcasting a message to, or communication between, actors (users) within a computer system to secure collaboration and exchanges between the actors. An actor may be a human, machine-based entity or computational entity, e.g. an oracle or a bot. The terms ‘actor’, ‘operator’, ‘user’ or ‘entity’ or ‘party’ may be used interchangeably herein.

The term ‘presence’ can be used to describe the actor's relationship to, and/or location/position within the domain. In physical form, an actor can be ‘present’ within a domain, or part thereof. A virtual actor, however, may not be physically present in a domain, or part thereof, but can be ‘present’ or have ‘presence’ by being pertinent. In other words, a virtual entity can be present within a domain by being operationally active or relevant to the domain and, therefore, operational or currently active e.g. in service or performing an action, or in an active or passive state within the domain. The term ‘presence’ can be applied to a virtual entity because it can be relevant or visible i.e. pertinent to other actors when they are in the same domain/zone or proximal one another.

Preferably, a domain comprises a zone or a plurality thereof. A zone can be defined as a particular area, region or part of a domain. One or more boundaries may be defined or calculated for a given zone. A zone may also be referred to as a ‘sub-zone’. A zone can comprise one or more further (sub) zones, such that a domain can comprise a hierarchy of zones. For simplicity and ease of reference, we will use the term ‘zone’. In our examples above, the term “room” has been used. In the following examples, the term ‘zone’ is used instead.

A zone within a given domain may be associated with one or more attributes which relate to, or determine, the state of that zone. For example, if the domain is a leisure centre comprising sub-zones “gym,” “pool” and “dance studio”, and attribute of “pool” sub-zone may be “has shower” while an attribute of “gym” might be “has treadmill”. In an example of a virtual domain, a domain may be a game environment and an actor (player/avatar) may move between different rooms, levels, worlds etc (zones) within the virtual environment; consider another example involving a simulation environment such as a medical simulation or an aircraft simulator. In some examples, a zone could be a virtual machine or code segment running on a computer, or a database etc.

Additionally, or alternatively, a zone may be associated with one or more functionalities or capabilities which can be performed by an actor that is associated with the zone. For example, an actor that is actively associated with a “pool” zone in a leisure centre may be able to perform the “start shower” action, or an actor actively associated with the “gym” may be able to perform the “change speed of treadmill” action. A player in a game may be able to move from one room in a building to another and pick up specified items within each room. Each zone may be associated with a set of rules that govern how actors within that room may operate, and how they may use any resources that are associated with that zone. Preferably, the attributes associated with a domain and/or one or more of its zones may be pre-determined by an administrator or controller in the sense that these attributes may not be altered by an actor within the domain. Similarly, the functionalities associated with zones may not be determined or altered by an actor. An actor may be deemed as “active” within a domain or zone when the actor becomes actively engaged or associated with the domain/zone. Each domain/zone may have its own security/authentication requirement(s) which an actor must satisfy in order to become an active member. These are described in more detail below.

The methods and systems herein support, generally, communications from at least one actor to all other actors in a domain, and between two or more actors occupying the same zone within said domain. The domain, and zones within the domain, are provided with functionality and/or attributes. The method herein can support monitoring and/or performing synchronisation of the functions performed by a plurality of operators in the same zone and/or the changes to the attributes. The system can be an application domain. The application domain can function as a mechanism or process, e.g. via implementing executed software applications that are separate/isolated from one another.

The domain can be a logical or technical space/environment that is based upon, or defined, in accordance with an implementation of an embodiment of the disclosure. In some preferred embodiments it may model a real-world entity or location, e.g. a building, such as a shopping centre, manufacturing facility or a warehouse, which is represented digitally. The domain, its zones, any functionality and/or attributes can be represented by a computer-based record system or database e.g. a distributed database or blockchain ledger. Alternatively, the domain, its zones, any functionality and/or attributes can be digital and represent, by way of example, an on-line game, a spreadsheet or graph database. By way of example, the domain and/or the zones can be represented as tokenised resources or entities. The functionality of a domain and/or the or each zone can implement rules that determine operations.

The examples herein describe technical solutions that enable a plurality of actors to perform operations upon or within a domain and/or zone of that domain. Operations can include at least one of controlling, influencing or directing an entity within a system e.g. actors acting upon the domain or part thereof. The methods herein enable the domain to maintain state consistency by enabling actors to communicate securely and/or privately. In this way, actors in a zone, or proximal to a zone, can collaborate to avoid overlap and support eventual consistency.

Further, a control and/or record system is disclosed for controlling and/or monitoring a system representing a domain (D), to track functions performed and/or changes to the variables of the zones within the system, which can benefit from permanent immutable records of changes to the variables of a zone, the functions performed by an operator in the zone or by the zone. A zone may be a technical environment that comprises part of a larger technical environment. In other words, a zone may be a sub-environment that forms part or a component of a system and/or parent/wider environment.

The methods herein can be applied, by way of non-limiting examples, to the following scenarios: two players in a game of on-line chess; two data analysts wishing to update the same cell in a spreadsheet; two or more autonomous robots accessing the same storage bin within a warehouse; safety systems for alerting when two vehicles e.g. planes come within a close proximity to each other etc; and determining the position of an electronic tag worn by a person, within a building or complex having zones, with respect to a particular zone and/or another tag worn by another person. When applied to the determination of a position of an electronic tag worn by a person, the method can support ensuring that offenders and/or, parolees are not in proximity to prohibited spaces such as victim's homes or liquor stores.

### Synchronisation—Overview

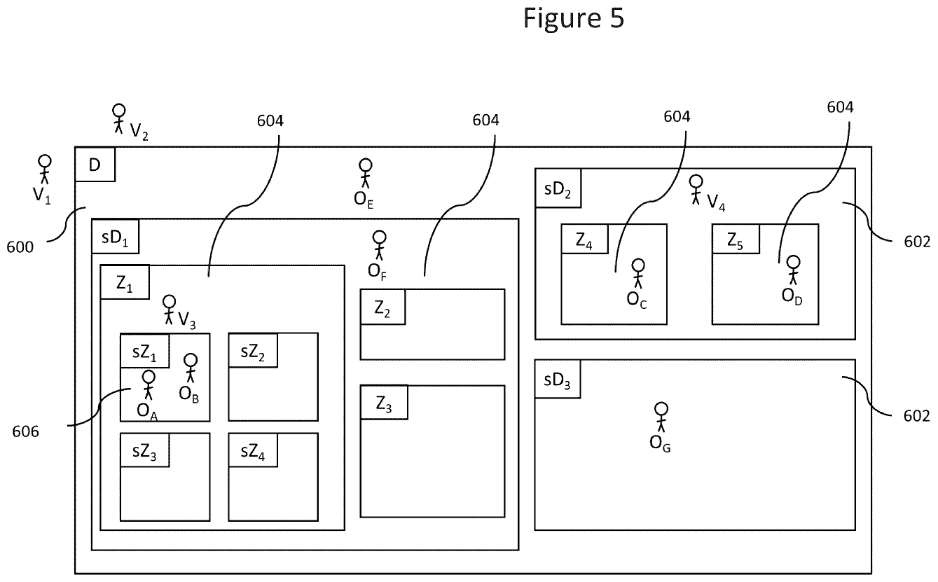

FIG. 5 schematically illustrates a plurality of operators (actors) On, labelled O_{A}, O_{B}, O_{C}, O_{D}, O_{E} and O_{F}, located in a domain (D). An operator can be a user or other type of actor e.g. a human, machine-based entity or computational entity, e.g. an oracle or a bot. The domain includes sub-domains sDn, labelled in this example as sD₁, sD₂ and sD₃. Sub-domains can have zones Zn, shown labelled as Z₁ to Z₅, and each zone can have a sub-zone sZn, labelled sZ₁ to sZ₄. The domain can additionally be occupied by parties that have read-only or view-only access to the status and/or operations of the domain and its zones—said parties are referred to as viewers V₁ to V₄. The domain D is described as shown for example only and the invention is not so limited. The number of sub-domains, zones and sub-zones will vary depending on the application and/or implementation of the invention.

In a digital domain, the zones can generically be referred to as virtual rooms, spaces, data structures or environments, implemented using programs or data rooms {Z₁, Z₂, Z₃ . . . Z_{N-1}}, which are functional and/or contain variables. These virtual rooms can be objects in programs that model the entities to be controlled. The models have functionalities, implemented by methods, functions and procedures that can be invoked at run time, and variables which provide static or dynamic states.

A sub-zone can be denoted by Z′, a sub-sub-zone being denoted by Z″, etc. Zones can be accessed/viewed through corresponding seeds {Z₁, Z₂, Z₃. . . . Z_{N-1}}. Knowing Z₁ permits (i) “unlocking” a zone to perform a function on or within said zone, Z₁ and (ii) reading the contents of Z₁. Each room has a corresponding “control” key {k₁, k₂, k₃ . . . k_{N-1}}. Being in possession of the control-key permits the holder to lock, unlock, modify or encrypt the zone or part thereof.

In the examples below, reference is made to two actors, O_{A} and O_{B}, nominally referred to as Alice and Bob, who intend to perform a function in a zone within a domain. In practice, Alice and Bob are indicative of a first actor and a second actor, respectively. While examples herein describe Alice and Bob as humans performing functions and interacting with the domain D, it is actors e.g. computational entities that function to at least one of provide communication, synchronisation, verification, authentication and security. For example, the zone can represent a storage bay in a warehouse, a location in a game, which can be digital and on-line, or a cell in a spreadsheet. If Alice and Bob are in the same zone or want to perform a function in relation to the zone then they can be aware of the other's presence and/or collaborate. Similarly, an actor such as Alice and Bob have no information about other actors e.g. their location, to maintain privacy.

The term ‘zone’ is the generic term used hereinafter to describe a segregable/defined portion of a domain D, which can in some embodiments be the smallest divisible area of a domain D, which is shown as sZ₁ in FIG. 5. In light of the teaching herein, it can be understood that the invention can enable a first actor to determine the presence and/or non-presence of a second actor in a zone, sub-zone, sub-domain or the domain itself. The level of granularity and awareness of ‘presence’ or ‘non-presence’ and, similarly ‘active’ and ‘non-active’ status can be configured according to the implementation.

Actors initially access the domain D and/or the digital representation of the domain through a log-in or similar security process in which operators/actors are verified and/or authenticated depending on the implementation. Upon accessing the domain each actor can be provided with their own label that enables the domain and/or other actors to identify and/or address the actor. The label is referred to herein as a tag. In the case of a biological actor, the tag can be physically worn or attached and function as the actor that holds the label. The tag can be configured according to the use-scenario, and can reside in at least one of: a digital format, wherein it resides in a program operating on a device having memory storing the tag, and is used during communications with other actors; and hardware, wherein a device stores the tag in its memory and/or a radio-frequency identification (RFID) device, and the device is attachable to a robot module or wearable e.g. a wrist band. The device and/or program holding the tag is configured to communicate with (i) the domain and any of the zones therein, and (ii) each of the actors within the domain. A label attributed to an actor is unique to said actor. It can be dynamically assigned each time an actor enters the domain, or it can be static, thus remaining with the actor. The label can be an alphanumeric code, which can be represented digitally or in physical form e.g. a QR code. The label can be a public address associated with a cryptographic key-pair. The label can be a public key value derived from an ephemeral private key. If the label is connected to a biological actor then the label can, at least in part, be derived from, or include, biometric data.

The domain D and each of the sub-domains, zones and sub-zones has an identifier S_{A} that distinguishes it from the other zones in the domain and enables an actor to determine their location within the domain (i.e. which zone they are in).

Actors are only able to obtain the identifier S_{A} when they are in the zone. By way of non-limiting examples, the identifier can be obtained by at least one of: reading a code e.g. barcode, that is displayed in the zone and readable using a vision system from a physical marking or a digital display; detecting a digital signal using radio-frequency e.g. RFID; and the identifier can be obtained by Alice communicating with the zone Z, which functions to manage its own identifier and any updates thereto, and Alice can receive and store the identifier. The identifier of a zone Z can be fixed or dynamic. If it is dynamic, it can be modified, replaced or updated in some other way. The trigger for updating can be at least one of: a period of time; an event or satisfaction of a condition such as a new actor entering the zone; an actor leaving the zone; or when the zone is vacated. In other examples, a controller such as a domain or zone administrator may initiate the update.

The zones Z within a domain or sub-domain sD can be nested. The example of FIG. 5 shows, by way of example, a sub-zone sZ₁ co-located with three other sub-zones in zone Z₁, which resides with two other zones in sub-domain sD₁, which resides in the domain D with two further sub-domains. For example, a cell in a table in a spreadsheet e.g. Excel (RTM) can be part of a row, or column, and said table can be one of a plurality of tabs within a specific file. Similarly, a storage bin within a warehouse can be located in a sub-area within the warehouse, on a particular row at a particular level. A zone can be configured with a plurality of identifiers, including: the identifier S_{A} that distinguishes it from the other zones in the domain; and at least one further identifier that identifies the zone's positional relationship with other zones. In other words, a further identifier can indicate the identity of at least one of: an adjacent zone, e.g. sZ₁ is next to sZ₂; the zone in which it is located, e.g. sZ₁ is within Z₁; and the sub-domain in which it is located, e.g. sZ₁ is within sD₁. A zone that informs actors of their relative position within the domain can enable actors to establish who is in the same zone and who is an adjacent zone.

A control system of the domain D can determine the positional relationships of all actors, e.g. the relative proximity or at least one actor and another actor, which can be important if one actor is prohibited from being in the same zone, or within a predetermined proximity of another actor.

A control system can at least one of: monitor and/or observe the actions taken by the actors; monitor and/or observe the functions or operations performed by the zone; and collate acquired data to enable a viewer V_{N} to have read-only or view-only access to the status and/or operations of the domain and its zones. View-only access can be domain wide e.g. as per viewers V₁ and V₂ in FIG. 5, or locally, as per viewer V₃. View only access can be permitted when the function provided by the domain is a forum that supports on-line games, e.g. Alice and Bob in sZ₁ are playing a game of chess.

The domain D, and each of the segregated areas e.g. the sub-domains sD, zones Z and sub-zones sZ are provided with functionality and/or attributes as required by the implementation of the invention herein. A zone Z can be represented digitally as a program, said program running on a machine having a processor and an associated memory. The machine can be configured locally to a zone, or centrally controlled remotely e.g. at a control centre for the domain D. In one example, a zone can be a storage bin within a warehouse and display the identification of the zone, which can be read by a robot configured to add or remove items from said bin. In another example, the zone can represent an on-line game e.g. chess, in which the program not only provides an identification of the zone but additionally controls the game rules or protocols, as well as an inventory of the pieces and their position in the game.

### Synchronisation—Communication

In context, Alice enters a domain having a plurality of zones. Alice can be a robot entering and operating in a warehouse and configured to place or retrieve items from a storage bin. Alternatively, Alice can be a human wearing a tag that functions as a mobile communication device e.g. a smart tag, such as a smart-watch. Further alternatively, Alice can be a player in an on-line game of chess, which she has entered via, for example, a user interface (UI) 500. Regardless of whether Alice has entered a physical space or a digital domain she can be inhibited e.g. for security reasons from knowing who else is in the domain or with whom she can communicate until contact is established. Moreover, if Alice is a robot and wishes to modify the inventory of a storage bin then she must collaborate with any other robots intending to do the same.

If another actor, e.g. Bob is present in the same zone, Alice must commit to the actions she performs in order to synchronise the status of the zone Z and inhibit overlapping actions and/or fraud. Synchronisation is particularly important, for example, when Alice and Bob are playing an on-line game, e.g. chess, or poker, wherein certainty of the actions taken is required. The examples herein enable actors to perform their functions and interact in a trustless system. They also avoid inconsistencies in data and state within the system.

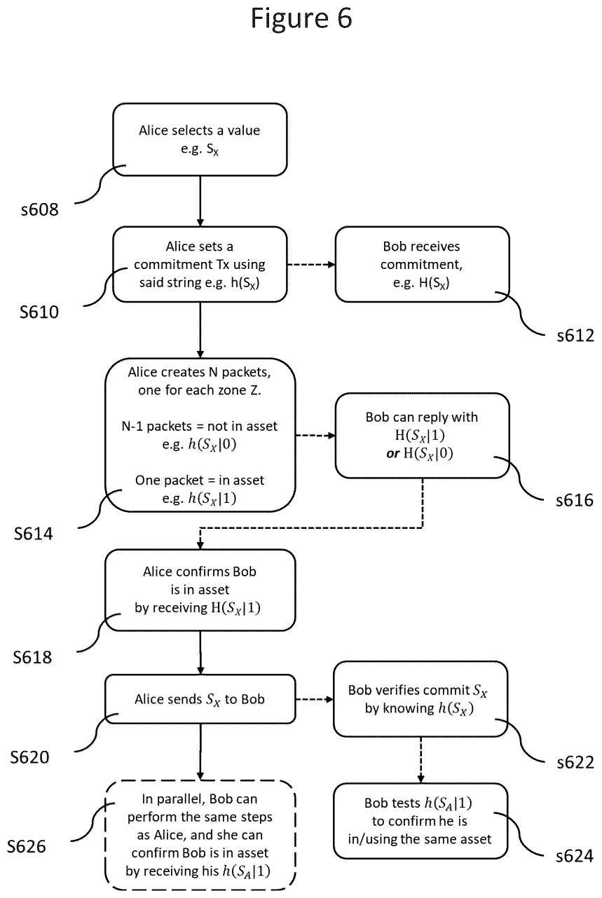

FIG. 6 illustrates, by way of example, a plurality of steps that provide (broadcast) the presence of a first actor, in this case ‘Alice’ (O_{A}) who resides or intends to function within a zone (Z) of a domain (D) having a plurality of zones (Z) analogous to FIG. 5. In one example, Alice resides in sZ₁, which has an identifier Z_{A}. It is to be noted that the steps describe Alice, or Bob, performing actions. However, in practice, Alice and/or Bob can be computer-based resources, such that the steps can be performed by an operating system, host, program or device that perform the steps and functions. This enables the actions to be performed automatically. It is to be noted that the domain, and parts thereof, can be software-implemented entities that can be implemented in hardware and/or execute as an application.

At s608, Alice creates a random string of bits, e.g. generates an ephemeral key, to establish a secret S_{X}. Further, Alice obtains the value of an identifier Z_{A} associated with the zone. This can be obtained from the zone itself In some examples, the identifier can be data obtained using a physical device, such as a QR code or barcode that can be read from at least one of a fixed display, digital display or RFID. In other embodiments, the identifier can be stored, requested, accessed and received via electronic means rather than via physical capture using a scanner, camera etc. Additionally or alternatively, the identifier can be obtained by Alice communicating with the zone Z, retrieving and storing the identifier.

At s610, uses her secret S_{X} to establish a commit. By way of example, Alice performs a hash operation on her secret, i.e. h(S_{X}) to produce a value H(S_{X}). Alice can send this to all actors in the domain D, which can be via each zone Z in the domain.

At s612, Bob, who happens to be in the same zone Z as Alice, receives and stores Alice's commitment. Bob, by being in the same zone as Alice, obtains from the zone the same identifier Z_{A}.

At s614, Alice prepares and broadcasts at least one transmission to all actors in the domain and/or to all zone Z in the domain. Each actor receives the transmission directly from Alice and/or via the zone Z. The transmission functions to communicate, for example by sending information via a message or packet of data, said information containing data that enables Bob to determine the presence of Alice in relation to the zone Z. Using the information e.g.

data in the transmission from Alice, Bob is able to compare said data against the data of the zone. The data can include the zone identifier Z_{A} or a derivative thereof. When Bob is in the same segregated area of the domain D i.e. he is in the same zone as Alice and can obtain the same zone identifier e.g. Z_{A}, then determines that he is present in the same zone as Alice.

Additionally, or alternatively, the data in Alice's transmission includes an identifier of any one of the segregable portion of a domain D. In this way, an identifier can indicate to another actor which part of the domain they are present such that the level of granularity and awareness of presence or non-presence can be configured according to the implementation. Using FIG. 5 by way of example, when Alice O_{A} resides in sZ₁, she can send a transmission including data that indicates that she is present in sZ₁, Z₁ and sD₁. The transmission can include the identifiers of each of sZ₁, Z₁ and sD₁, or three separate transmissions can be made for each of the respective zones. By way of example, an actor O_{F}—Frankie—resides in a sub-Domain sD₁ to whom Alice broadcast at least one transmission indicating her presence (which indicated her presence in each of sZ₁, Z₁ and sD₁). The data in the transmission only enables Frankie to only determine that Alice resides in the same sub-domain, he cannot determine what zone or sub-zone she occupies.

At s616, Bob, or indeed Frankie, determine Alice's presence in the same segregated area by reading the transmission. They can reply with verification, which they can provide because they have access to the same identifier of the segregated area in which they reside. To be clear, Alice sends a transmission that enables Bob to confirm Alice's presence and/or non-presence in a segregated area, and Bob can send a response verifying his location in the domain.

At s618, Alice receives Bob's verification. Thereafter, at S620, Alice can provide her secret S_{X} as proof of the earlier commitment, which Bob can verify at S622.

Bob, of course, can repeat the same steps as Alice, such that they both make transmissions that enable the other to determine their presence. Different zones are configured with different functionality that determines the rules or protocols under which actors must abide by.

In the example of FIG. 6, the data in Alice's transmission enables her presence to be determined by someone that resides in the segregated area, and she uses the identifier as her secret S_{X} to establish a commitment and within the data of transmission i.e. secret S_{X}=identifier Z_{A}. As shown in FIG. 6, Alice sends a commitment to Bob using her secret at s610. At step s614, Alice creates a transmission including data that only Bob, or another actor in the same segregated area as Alice can use to determine Alice's presence. Bob can determine Alice's presence because he also knows the identifier.

In the example of FIG. 6, at least two different transmissions are made: one transmission has data comprising a concatenation of the identifier (S_{X}, Z_{A}) and a binary value of ‘1’, i.e. S_{X}|1, which is at least one of (i) transmitted to all actors in the domain, and (ii) sent to the zone in which Alice resides; and at least another transmission has data comprising a concatenation of the identifier (S_{X}, Z_{A}) and a binary value of ‘0’, i.e. S_{X}|0, which is at least one of (i) transmitted to all actors in the domain, and (ii) sent to the zones in which Alice does not reside. The binary values that are concatenated with the identifier S_{X} can be referred to as an indicator.

The concatenated values of the identifier and the indicator are used to create a commitment, which forms part of the data in a transmission s614, which in the present example is hash value of said concatenation e.g. h(S_{X}|1) and h(S_{X}|0). Each of the other actors, including Bob, can reply with confirmation of their location by sending a corresponding reply e.g. H(S_{X}|1) and H(S_{X}|0), as step S616. Alice can review the reply e.g. H(S_{X}|1) and H(S_{X}|0) at S618, and then send S_{X} to Bob at s620 in order that he can verify at s622 the earlier commitment made by Alice at s610.

Using at least a second transmission that indicates that Alice is not present in a zone avoids Alice, or other actors, revealing their location to anyone other than those who are in the same zone.

In the example of FIG. 6, the identifier S_{X} is concatenated with an indicator that is a binary value. An alternative to concatenating the identifier and the indicator can be, for example, an XOR operation. Further, the indicator is not limited to non-binary values. For example, the identifier of the zone can be concatenated with an indicator that informs the recipient of at least one of the level of access, presence and/or intention of the first actor in relation to at least one of the zone (Z), the domain (D), the sub-domain (sD) and the sub-zone (sZ).

Overall, the at least one transmission and/or the second transmission comprises an operation upon an identifier and an indicator, which by way of example is a hash of the concatenation i.e. h(R₁|p) and/or h(R₁|q), wherein h represents a hash function applied to the transmission, R1 is the identifier of the zone (Z), the domain (D), the sub-domain (sD) or the sub-zone (sZ) in which the first actor is present, and |p and |q are indicators concatenated with the zone identifier that provides additional information to another actor. that inform the recipient of at least one of the level of access, presence and/or purpose of the first actor in relation to the zone.

As described above, an identifier can be unique for each segregated area e.g. the zone (Z), a sub-domain (sD) and a sub-zone (sZ) and can be generated by a functional zone. Identifiers can be derived from a master key and/or updated at predetermined intervals.

### Domain—Example Implementations

The examples herein apply to a domain (D) having segregated areas that, for example, have their own functions and/or operate according to their own rules or protocols. The domain, or part thereof, can be at least one of: a physical entity represented by spatial or geospatial data e.g. a warehouse; representable as a virtual zone in a virtual domain e.g. a digital representation of the warehouse and/or its contents; and representable as an entry within a database or data table e.g. wherein a storage bin within a warehouse can be documented by an entry on a spreadsheet. Examples herein are provided to illustrate the functionality of the systems and methods taught herein, and the invention as claimed is not so limited.

In an example in which Alice and Bob are robots operating to store or collect items from a segregated area e.g. storage bin within a warehouse, the or each robot must determine whether they are alone in said storage bin before modifying the quantity of items. Referring to FIG. 6, Alice can create a commitment s608 and/or broadcast a transmission s614, in which data is securely exchanged such that only those robots present in the same storage bin are aware of Alice's presence. Other robots e.g. Bob, perform the same actions to determine that Alice is present. Thereafter, each robot can communicate to commit to add or remove items from the storage bin to inhibit any errors in the stock count. By way of example, the functionality of the storage bin can be represented as a program controlling a tokenised resource. Alice and Bob can establish secure communication between themselves and/or between other robots operating to modify the stock in said storage bin. Additionally or alternatively, actors can establish a secure communication channel with the program to interact with the stock in the storage bin.

In an example in which Alice and Bob play a game of chess, the domain can be an on-line gaming platform to which Alice and Bob subscribe. Referring to FIG. 5, they are assigned a board in a segregated area sZ₁, wherein game is controlled by a program. The program can record the game by updating the status of a tokenised resource. Any actor that has accessed the platform can view the game, or a group of games within a larger segregated area e.g. a viewer V₃ within zone Z₁ can observe four games, namely those in areas labelled sZ₁ to sZ₄. Zones can be accessed/viewed by obtaining seeds {Z₁, Z₂, Z₃ . . . Z_{N-1}} corresponding to each of the segregated areas. Only those participating in a game are permitted to unlock a zone to perform a function, such as move a chess piece, said permission provided via obtaining a corresponding “control” key {k₁, k₂, k₃ . . . k_{N-1}}. Although Alice and Bob have accessed the gaming platform and selected to play a game of chess, they are otherwise unaware of the other's presence. Using one or more steps described herein, Alice and Bob at least one of: determine the others presence, e.g. allowing one player to know that the other player is still playing; exchange commitments e.g. to determine that a move has been made, and completed; and establish new shared secrets, using, for example, the identifier of the zone, that enable players to communicate securely without exchanging private keys e.g. as described in WO2017/145016, herein incorporated by reference in its entirety. The program controlling the game and/or Alice and Bob can interact with a token that represents the game and records the stats of the board, and a history of the moves, in one or more transactions.

An analogy can be drawn between a game of chess and the control of a spreadsheet or other database having organised data or values, e.g. a cell in an Excel (RTM) spreadsheet, which can hold a value that is entered directly or derived from a formula based on values in other cells. Once again, actors access a domain e.g. a database, and using one or more steps described herein, Alice and Bob at least one of: determine the others presence, e.g. allowing one actors to know that another actor intends to modify the contents of a call, or not; exchange commitments e.g. to determine that the changes made to the value of the cell and/or the formula do not overlap and result in an error; and establish new shared secrets, using, for example, the identifier of the cell, which can be required if the purpose of the change is confidential and must remain secure.

In yet another non-limiting example, the domain can be one of a school, prison or leisure centre and the actors wear tags, e.g. a smart watch, which is personal to them. The tag, or smart watch, is an electronic device configured to implement the methods herein alone or in combination with a domain control system. The domain can be implemented at any scale e.g. a road network, or a city. A tag can operate autonomously to implement the methods herein and, by way of example, at least determine which other actors are in the same zone and/or proximity. A tag can provide an audible and/or haptic warning is, for example, an actor is not permitted in a zone and/or the tag determines that a first actor's presence with another actor's presence is, for example, prohibited via a restraining order. The tag can determine what functions an actor can perform in collaboration with another actor and/or within the zone itself.

The domain can include a control system that can monitor and determine at least one of: the quantity of actors in a given area; and the relative proximity of actors to each other. The control system can take action, for example, to at least one of: warn an actor—through communication with the tag and/or through the zone—that there are too many actors in one segregated area e.g. zone; and restrict access e.g. by preventing entry through an electronically secured door.

As suggested above, a zone's functionality and/or variables can be controlled using a tokenised resource, e.g. a UTXO residing on a blockchain. A domain and the zones therein can be controlled by at least one program operating on a machine to enable actors to determine the presence or non-presence of another actor, and their relative proximity. The or each program can be implemented on at least one of a distributed data structure, and configured on a distributed ledger e.g. a blockchain ledger.

### Domain—Security Enhancement

Establishing secure communications between actors using shared secrets has been described above with reference to WO2017/145016. It is to be noted that the transmission can be further enhanced by communicating a secret as disclosed in WO2019/220298,herein incorporated by reference in its entirety.

### Conclusion

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

The invention generally resides in a computer-implemented method that uses blockchain content to encrypt or decrypt data, or part thereof. The content can be bespoke i.e. a unique parameter or reference. The content is used as an input to an encryption or decryption process.

### Enumerated Clauses

It will be appreciated that the above embodiments have been described by way of example only. More generally there may be provided a method, apparatus, system or program in accordance with any one or more of the following Clauses or substantially as described/illustrated herein.

A zone may also be called a ‘data structure’ or an ‘environment’. It may be analogous to a room in a larger structure. An actor may be called a user or an operator. A domain may be called a computing system and may comprise a one or more of physical, virtual software and/or firmware-based resources e.g. network architecture, virtual machine(s), code segment(s) etc. In some examples, a room may be provided using an execution thread, process or instance running on a processor.

In one or more embodiments: an actor may be a subscriber to an IPv6 multicast group; an actor may ‘enter’ or ‘leave’ a zone by subscribing/unsubscribing to an IPv6 multicast group.

The clauses generally related to broadcasting a presence of a first actor (O₁) within a zone, or their proximity to said zone, (Z) of a domain (D) comprising a plurality of zones (Z). The term ‘presence’ and ‘proximity’ can be used to describe the actor's relationship to and/or location/position relative to the domain. In physical form, an actor can be ‘present’ within a domain, or proximal to said domain, or a part thereof. A virtual entity, however, may not be physically present in or proximal to a domain, or part thereof, but can be proximal, be ‘present’ or have ‘presence’ by being pertinent to the domain or a part thereof. In other words, a virtual entity can be present within a domain by being pertinent and, therefore, operational or currently active e.g. in service. The term ‘presence’ and ‘proximal’ can be applied to a virtual entity because it can be relevant or visible/visible i.e. pertinent to other actors when they are in the same domain/zone.

The teaching herein can be applied to real-world scenarios or situations, or representations thereof, wherein a first actor (user) is able to make their presence or pertinence known to another (i.e. at least one other) actor e.g. that they are operational or currently active e.g. in service in a zone. Additionally, or alternatively, ‘pertinence’ may comprise the interpretation of ‘being relevant to’, ‘wishing to operate or be active within’ and/or ‘needing to interact with’. The at least one other actor may determine the presence, proximity or status of the first actor by being in the same zone or proximal said zone. The at least one other actor may need to be present or pertinent to determine the proximity or status of the first actor. The at least one other actor can be limited to determining the non-presence of another actor.

In the example clauses, the first actor (O₁) may be Alice and/or the at least one other actor may be Bob, or actors authorised by Alice/Bob to act on their behalf.

Clause 1: In one aspect, there resides a computer-implemented method comprising the step of broadcasting, indicating or otherwise providing a presence of a first actor (O₁) within a zone (Z) of a domain (D) comprising a plurality of zones (Z). The broadcasting step may be performed by the first actor (O₁). The first actor may send, indicate or otherwise provide to at least another (i.e. at least one other) actor (O₂) within the domain, data that enables the at least one other actor (O₂) to determine the proximity of the first actor in relation to the zone (Z).

The first actor may send, indicate or otherwise provide the data to the at least one other actor by sending at least one transmission comprising the data, or means for calculating/obtaining the data.

The data may comprise a secret. The secret may be, or comprise, an identifier. The secret/identifier may be or comprise a key or means for generating a key. The key may be a cryptographic key. The secret/key/identifier may be derived from, or otherwise obtained using, a master secret/key/identifier.

In accordance with an additional or alternative form of wording, there may be provided a computer-implemented method comprising the step of:
sending, from a first actor (O₁) to at least one other actor, data that enables the at least one other actor (O₂) to determine the proximity of the first actor relative to a zone (Z) within a domain. Determination of the first actor's proximity to the zone may comprise determination of the first actor's presence within the zone and/or absence from the zone. ‘Presence’ may comprise physical presence or virtual presence, depending to the application. Virtual presence may comprise, for example, the first actor's active status, membership of, or association with respect to the zone.

The domain can be a network, and can be used to define, or be defined by, an environment or domain, such as a warehouse. A zone can be an asset within the domain, and can be used to define, or be defined by, a sub-environment or sub-domain. A zone can be a component of a domain.

The first actor can make their presence known via at least one transmission, which is sent to at least one other actor (O₂) within the domain. The transmission can be at least one of a communication, message and packet. The at least one other actor can be limited to determining the non-presence of another actor from the data in the transmission.

Thus, in some embodiments, the disclosure may enable an actor to monitor the domain, or part thereof, and/or enable a plurality of actors to determine the presence of other actors, engage and interact with them within the current zone that they occupy i.e. are present in. The domain, and parts thereof, can represent real-world and/or digital assets. The assets can have functions and/or variables. Embodiments provide enhanced and cryptographically secure solutions for processing of sensitive or secret data within the domain, and provides a platform and/or underlying mechanism which a wide variety of technical implementations can utilise for advantage.

Clause 2: The first actor (O₁) can further send at least one further transmission, said at least one further transmission containing data that enables the at least one other actor (O₂) to determine the proximity of the first actor in relation to the zone (Z) in the domain (X).

For example, the data that enables the determination of the presence of the first actor can be zone e.g. location dependent. Therefore, only other actors able to access the same data can verify the presence of the first actor. For example, the data can include an identifier of a room within a hotel. The data can further include data indicating, for example, which floor or wing the first actor resides in. In this way, only other actors in the same floor, wing or room can determine the presence of the first actor e.g. in the same room and/or the proximity e.g. in the same wing or same floor of the hotel.

Clause 3: The first actor can send the at least one transmission and/or the at least one further transmission to all actors present in the domain (D).

By sending information to all other actors, and all other actors performing the same actions, the first actor can determine the presence and/or proximity of all other actors in the zone and/or domain. The actions performed by the actors can, therefore, take into account other's actions upon the same zone or assets therein. The actors are, therefore, able to synchronise their actions when actions of a plurality of users is likely to occur at different times thus inhibiting overlapping/conflicting outcomes, thus supporting the eventual consistency of the domain and the zones therein.

Clause 4: The domain (D) further includes at least one of a sub-domain (sD) and a sub-zone (sZ).

Clause 5: The at least one of the zone (Z), the domain (D), the sub-domain (sD) and the sub-zone (sZ) can comprise an identifier.

Clause 6: The identifier may be at least one of:
unique for each of the zone (Z), the domain (D), the sub-domain (sD) and the sub-zone (sZ); derived from a master key;
included in the at least one transmission and/or the at least one further transmission;
updated at predetermined intervals; and generated by at least one of the zone (Z), the domain (D), the sub-domain (sD) and the sub-zone (sZ);
modified, replaced or otherwise updated. In some example embodiments, this may be performed at predetermined intervals (e.g. every hour), or upon satisfaction of a specified condition (e.g. if more than 5 actors are present in the zone), or upon performance of a triggering event (e.g. an administrator or other controller has initiated the update. The identifier may be generated by at least one of the zone (Z), the domain (D), the sub-domain (sD) and the sub-zone (sZ).

The identifier can function to enable an actor to determine their presence. Additionally, or alternatively, the identifier provides a unique and updatable means for enabling actors within the domain/zone to transmit dynamic changes to their presence. For example, each actor within the domain/zone, operating and/or moving around between zones of the domain can transmit data indicating their presence each time they change zones within the domain and/or transmit data at regular intervals. With all actors transmitting data, the presence of all actors can be determined and/or monitored dynamically. In other words, the movement and/or operations of the actors can be continuously tracked and recorded.

Clause 7: The at least one transmission and/or the at least one further transmission can comprise: a commitment identifying the presence and/or non-presence of the first actor;

and/or a commitment to perform a function in the zone and/or modify a property (attribute) of the zone.

The data of the transmission can function to communicate a message, such as an indication of a planned action, in a secure manner. A commitment can be used to establish a shared secret between two or more actors that are aware of each other's presence.

Clause 8: The at least one transmission and/or the at least one further transmission can contain or otherwise include an indicator, wherein said indicator informs the recipient of at least one of the level of access, presence and/or purpose of the first actor in relation to at east one of the zone (Z), the domain (D), the sub-domain (sD) and the sub-zone (sZ).

Additionally, or alternatively to communicating their presence, the data of the transmission sent by a first actor can function to determine the hierarchy or order in which actions within the zone of a domain are taken.

Clause 9: The at least one transmission and/or the further transmission can comprise h(R₁|p) and/or h(R₁|q),
wherein:
   h represents a hash function applied to the at least one transmission and/or the at least one further transmission;
   R1 is the identifier of the zone (Z), the domain (D), the sub-domain (sD) or the sub-zone (sZ) in which the first actor is present, and
         |p and |q are indicators concatenated with the zone identifier and that inform the recipient of at least one of the level of access, presence and/or purpose of the first actor in relation to the zone.

Clause 10: The zone (Z), the domain (D), the sub-domain (sD) or the sub-zone (sZ) is at least one of: a physical entity represented by spatial or geospatial data; and representable as a virtual zone in a virtual domain; and representable as an entry within a database or data table.

Clause 11: The zone (Z), the domain (D), the sub-domain (sD) or the sub-zone (sZ) can comprise: functionality and/or variables; and/or is controlled by a program representing the zone.

Clause 12: The domain (D) can be at least one of a distributed data structure and/or configured on a distributed ledger.

Clause 13: The method can further comprise at least one of: engaging and/or communicating with another actor; securing the zone; and modifying the variables of the zone.

Upon establishing the presence of another actor in a zone, the first actor can liaise with the another actor to establish secure communications between themselves and/or with the zone. Additionally or alternatively, actors present in a zone can liaise to modify the status or variables of the zone.

Clause 14: The operation and/or the variables of each zone and/or the domain can be recorded, at least in part, on at least one of: a database, and a blockchain ledger.

Clause 15: The method can further comprise receiving a reply transmission from the at least another actor (O₂) within the domain, said reply transmission enabling the first actor to determine the presence and/or non-presence of said at least another actor.

Clause 16: The method can further comprise broadcasting a commitment to all actors in the domain (D), said commitment representing the identity of the first actor first actor (Oₙ), and upon determining the presence of the at least another (O₂), providing proof of the commitment, and establishing secure communication with the at least another actor.

Clause 17: In another aspect, a computer-implemented method comprises: controlling and/or monitoring a system representing a domain (D) comprising a plurality of zones (Z); receiving a broadcast of a transmission indicating the presence of a first actor (Oₙ) within a zone (Z) of a domain (D) comprising a plurality of zones (Z); receiving form the domain and/or the zone data that enables the system to determine the presence and/or non-presence of another actor in relation to the zone (Z).

Clause 18: At least one of a plurality of zones can be implemented using tokenised resource.

In another aspect, there resides a computer equipment comprising: memory comprising one or more memory units; and processing apparatus comprising one or more processing units, wherein the memory stores code arranged to run on the processing apparatus, the code being configured so as when on the processing apparatus to perform a method, as claimed.

In another aspect, there resides a computer program embodied on computer-readable storage and configured so as, when run on one or more processors, to perform a method, as claimed.

### Blockchain-Related Background

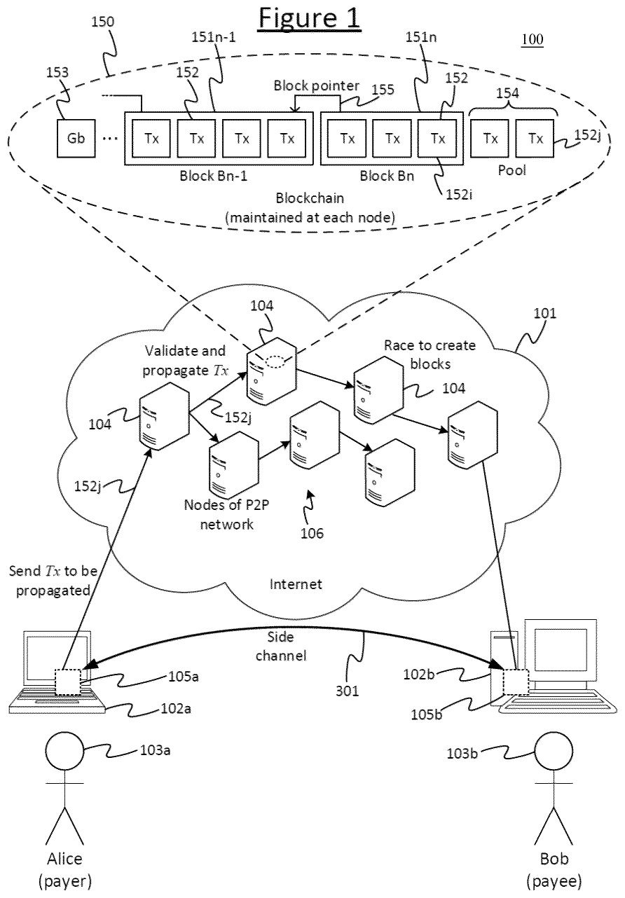

With particular reference to FIGS. 1 to 4, the following is provided by way of background information in respect of blockchain-implemented technologies, which can provide an implementation environment for certain embodiments of the disclosure.

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### Example System Overview

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits

(ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction can be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i can equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom can be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but can in principle be other user terminals). It is also not excluded that the party 103 enacting the new transaction 152j can send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it can simply be fixed by the blockchain node protocol alone, or it can be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 can take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality can be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this can be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition can simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

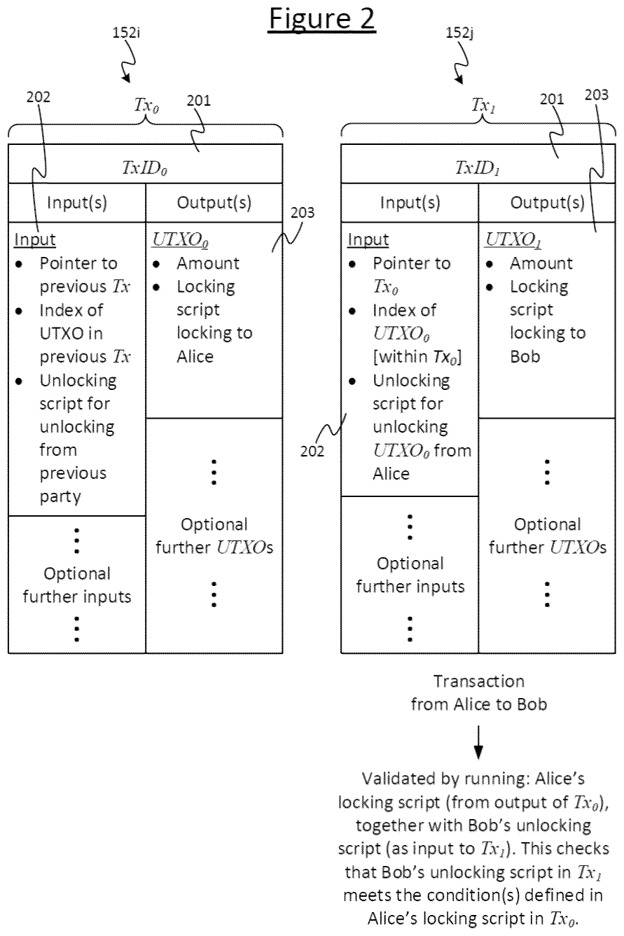

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ can point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ can be created and sent to the network 106 together, or Tx₀ can even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They can equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g.

by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}>which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥|[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore, such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However, the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they do not want to). In some protocols, the transaction fee does not require its own separate output 203 (i.e. does not need a separate UTXO). Instead, any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively, or additionally however, it is not necessarily excluded that a transaction fee can be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data can comprise a document which it is desired to store in the blockchain.

Typically, an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language can be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance, this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively, or additionally, the side channel 107 may be used to exchange any other transaction related data, such as keys, negotiated amounts or terms, data content, etc.

The side channel 107 may be established via the same packet-switched network 101 as the blockchain network 106. Alternatively, or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

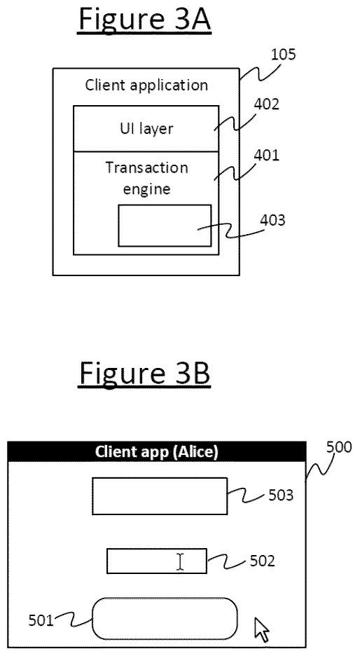

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example, the user output means can comprise one or more display screens (touch or non-touch screen) for providing a visual output, one or more speakers for providing an audio output, and/or one or more haptic output devices for providing a tactile output, etc. The user input means can comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they can be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 can be split between more than one application. Nor is it excluded that some or all of the described functionality can be implemented at, say, the operating system layer. Where reference is made anywhere herein to a single or given application 105, or such like, it will be appreciated that this is just by way of example, and more generally the described functionality can be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively, or additionally, the UI elements may comprise one or more data entry fields 502, through which the user can . . . These data entry fields are rendered via the user output means, e.g. on-screen, and the data can be entered into the fields through the user input means, e.g. a keyboard or touchscreen. Alternatively, the data can be received orally for example based on speech recognition.

Alternatively, or additionally, the UI elements may comprise one or more information elements 503 output to output information to the user. E.g. this/these can be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

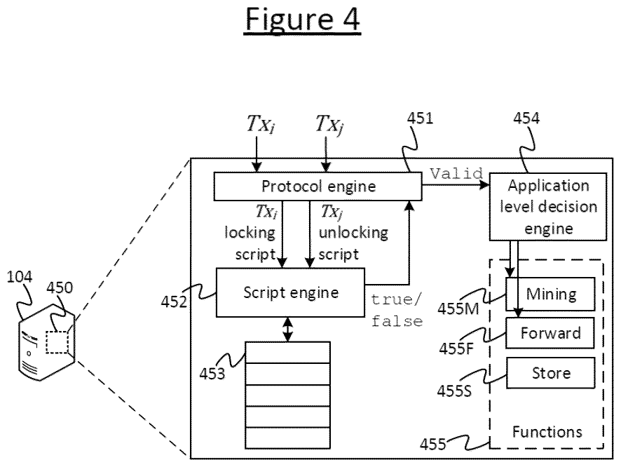

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152ⱼ (Txⱼ) is received having an input pointing to an output (e.g. UTXO) of another, preceding transaction 152ᵢ (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same can apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise, it returns the result “false”.

In an output-based model, the result “true” from the script engine 452 is one of the conditions for validity of the transaction. Typically, there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” can be indicated by a combination of an implicit, protocol-level validation of a signature and an additional affirmative output of a smart contract (the overall result being deemed to signal true if both individual outcomes are true).

1. A computer-implemented method comprising:
broadcasting a presence of a first actor (O₁) within a zone (Z) of a domain (D) comprising a plurality of zones (Z); wherein:
the first actor (O₁) sends, to at least one other actor (O₂) within the domain, at least one transmission containing data that enables the at least one other actor (O₂) to determine a proximity of the first actor in relation to the zone (Z).

2. The method of claim 1, wherein
the first actor (O₁) further sends at least one further transmission, said at least one further transmission containing data that enables the at least one other actor (O₂) to determine the proximity of the first actor in relation to the zone (Z) in the domain (X).

3. The method of claim 2, wherein
the first actor sends the at least one transmission and/or the at least one further transmission to all actors present in the domain (D).

4. The method of claim 2, wherein
the domain (D) further includes at least one of a sub-domain (sD) and a sub-zone (sZ).

5. The method of claim 4, wherein
at least one of the zone (Z), the domain (D), the sub-domain (sD) and the sub-zone (sZ) comprise an identifier.

6. The method of claim 5, wherein:
i) the identifier is unique for each of the zone (Z), the domain (D), the sub-domain (sD) and the sub-zone (sZ);
ii) the identifier is, comprises or is derived from a master key,
iii) the identifier is included in the at least one transmission and/or the at least one further transmission,
iv) the identifier is modified, replaced or updated, preferably at predetermined intervals, or upon satisfaction of a specified condition, or upon performance of a triggering event;
v) the identifier is generated by at least one of the zone (Z), the domain (D), the sub-domain (sD) and the sub-zone (sZ).

7. The method of claim 2, wherein the at least one transmission and/or the at least one further transmission comprises:
a commitment identifying the presence and/or non-presence of the first actor; and/or a commitment to perform a function in the zone and/or modify a property of the zone.

8. The method of claim 2, wherein the at least one transmission and/or the at least one further transmission contains an indicator, wherein said indicator informs the recipient of at least one of the level of access, presence and/or purpose of the first actor in relation to at least one of the zone (Z), the domain (D), the sub-domain (sD) and the sub-zone (sZ).

9. The method of claim 2, wherein the at least one transmission and/or the at least one further transmission comprises h(R₁|p) and/or h(R₁|q), wherein h represents a hash function applied to the at least one transmission and/or the at least one further transmission R1 is the identifier of the zone (Z), the domain (D), the sub-domain (sD) or the sub-zone (sZ) in which the first actor is present, and |p and |q are indicators concatenated with the zone identified that that inform the recipient of at least one of the level of access, presence and/or purpose of the first actor in relation to the zone.

10. The method of claim 4, wherein the zone (Z), the domain (D), the sub-domain (sD) or the sub-zone (sZ) is at least one of:
a physical entity represented by spatial or geospatial data; and
representable as a virtual zone in a virtual domain; and
representable as an entry within a database or data table.

11. The method of claim 4, wherein the zone (Z), the domain (D), the sub-domain (sD) or the sub-zone (sZ):
comprises functionality and/or variables; and/or
is controlled by a program representing the zone.

12. The method of claim 1, wherein the domain (D) is at least one of
(i) a distributed data structure, and/or
(ii) configured on a distributed ledger.

13. The method of claim 1, further comprising at least one of
engaging and/or communicating with another actor,
securing the zone, and
modifying the variables of the zone.

14. The method of claim 1, wherein the operation and/or the variables of each zone and/or the domain is recorded, at least in part, on at least one of: a database, and a blockchain ledger.

15. The method of claim 1, further comprising receiving a reply transmission from the at least one other actor (O₂) within the domain, said reply transmission enabling the first actor to determine the presence and/or non-presence of said at least one other actor.

16. The method of claim 1, further comprising
broadcasting a commitment to all actors in the domain (D), said commitment representing the identity of the first actor first actor (Oₙ), and
upon determining the presence of the at least another actor (O₂), providing proof of the commitment, and
establishing secure communication with the at least one other actor.

17-18. (canceled)

19. Computer equipment comprising:
memory comprising one or more memory units; and
processing apparatus comprising one or more processing units, wherein the memory stores code arranged to run on the processing apparatus, the code being configured so as when on the processing apparatus to perform a method of:
broadcasting a presence of a first actor (O₁) within a zone (Z) of a domain (D) comprising a plurality of zones (Z), wherein:
the first actor (O₁) sends, to at least one other actor (O₂) within the domain, at least one transmission containing data that enables the at least one other actor (O₂) to determine a proximity of the first actor in relation to the zone (Z).

20. A non-transitory computer readable media comprising a computer program product configured so as, when run on one or more processors, the one or more processors perform a method of
broadcasting a presence of a first actor (O₁) within a zone (Z) of a domain (D) comprising a plurality of zones (Z), wherein:
the first actor (O₁) sends, to at least one other actor (O₂) within the domain, at least one transmission containing data that enables the at least one other actor (O₂) to determine a proximity of the first actor in relation to the zone (Z).
